(19) United States
(12) Patent Application Publication
(10) Pub. No.: US 2025/0116949 A1
(43) Pub. Date: Apr. 10, 2025

(54) TONER

(71) Applicant: CANON KABUSHIKI KAISHA, Tokyo (JP)

(72) Inventors: ICHIRO KANNO, Chiba (JP); MARI KABURAGI, Chiba (JP); TORU TAKAHASHI, Ibaraki (JP); RYUICHIRO MATSUO, Ibaraki (JP); HITOSHI SANO, Chiba (JP); HAYATO IDA, Ibaraki (JP); YUYA CHIMOTO, Chiba (JP)

(21) Appl. No.: 18/906,797

(22) Filed: Oct. 4, 2024

(30) Foreign Application Priority Data
Oct. 6, 2023 (JP) 2023-174000

(51) Int. Cl. G03G 9/093; G03G 9/08

(52) U.S. Cl. CPC G03G 9/09385; G03G 9/0821; G03G 9/09342

(57) ABSTRACT

A toner including a toner particle and a composite particle present on a surface of the toner particle. The composite particle includes a fine particle A containing, as a binder component, an organic silicon compound, and a fine particle B which is an inorganic fine particle. The fine particle B is present in a state where a part of the fine particle B is embedded in a surface of the fine particle A. Proportions of silicon atoms in bifunctional to tetrafunctional silane monomers of the fine particle A satisfy predetermined relationships. A primary particle of the fine particle B has a number average particle diameter of 0.01 μm or greater and 0.06 μm or less. An average value of embedding ratios of the fine particle B to the fine particle A in the composite particle is 30% or greater and 90% or less.

### BACKGROUND

### Field

The present disclosure relates to a toner used for an electrophotographic method, an electrostatic recording method, or the like.

### Description of the Related Art

In recent years, an electrophotographic type full-color copying machine has been widely used, and has begun to be applied to the printing market. In the printing market, there has been a demand for performing printing at a low running cost in addition to the requirements for printing at a high speed with a high image quality and high productivity while dealing with a wide range of media (paper types) including cardboard and coated paper.

A technique of fixing a toner at a lower temperature has been examined in order to reduce the power consumption in a fixing step as energy saving measures. For example, low-temperature fixability and heat-resistance storage stability of a toner having a sea-island structure (matrix domain structure) in which a crystalline region containing a crystalline resin is considered as the sea and a non-crystalline region containing a colorant is considered as an island are examined in Japanese Patent Laid-Open No. 2014-66994.

Further, Japanese Patent Laid-Open No. 2022-102117 describes an example of using a crystalline vinyl resin in a resin component of toner particles as a material that achieves both low-temperature fixability and abrasion resistance of a toner with respect to coated paper. The crystalline vinyl resin has a main chain skeleton and long-chain alkyl groups as side chains. Further, the long-chain alkyl groups as side chains are regularly arranged and crystallized, and thus the resin exhibits crystallinity.

Meanwhile, when media such as coated paper, to which a toner is unlikely to be fixed, are used, a so-called phenomenon “scratch scraping” in which image defects are caused by peeling off of a printed toner due to a strong stress from the outside such as contact with a person's fingernail or a sharp object may occur in addition to a disadvantage of abrasion.

As measures to address the disadvantages, the process speed is decreased, and the toner is sufficiently melted and firmly fixed to media in a case of performing printing on media such as coated paper.

However, high productivity is required in the printing market, and thus it is necessary to achieve higher speed printing while dealing with various media.

### SUMMARY

The present disclosure provides a toner that realizes high productivity required in the printing market without causing scratch scraping even in a case where a strong stress is applied from the outside when media such as coated paper to which a toner is unlikely to be fixed is used.

According to the present disclosure, there is provided a toner including: a toner particle containing a binder resin and crystalline polyester; and a composite particle present on a surface of the toner particle, in which the composite particle includes a fine particle A containing, as a binder component, an organic silicon compound that has a siloxane bond, and a fine particle B which is an inorganic fine particle, the fine particle B is present in a state where a part of the fine particle B is embedded in a surface of the fine particle A, Pa is a proportion of a silicon atom represented by Si^{a} in a structure represented by a unit (a), Pb is a proportion of a silicon atom represented by Si^{b} in a structure represented by a unit (b), Pc is a proportion of a silicon atom represented by Si^{c} in a structure represented by a unit (c) based on all silicon atoms contained in the organic silicon compound of the fine particle A, and Pa, Pb, and Pc satisfy Expressions (1) to (3),

$$\begin{matrix}( 1 ) P a + P b + P c \geq 0.80 \\ ( 2 ) Pb + Pc \geq 0.30 \\ ( 3 ) P a / ( P a + Pb + Pc ) \leq 0.7\end{matrix}$$

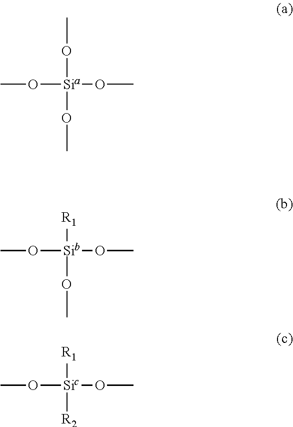

R₁ and R₂ represent an alkyl group having 1 or more and 6 or less carbon atoms,
a primary particle of the fine particle B has a number average particle diameter of 0.01 μm or greater and 0.06 μm or less, and
an average value of embedding ratios of the fine particle B represented by the following equation to the fine particle A in the composite particle is 30% or greater and 90% or less.

Embedding ratio (%) of fine particle B to fine particle A=(depth of fine particle B embedded in fine particle A/diameter of fine particle B)×100

Further features of the present disclosure will become apparent from the following description of exemplary embodiments.

### DESCRIPTION OF THE EMBODIMENTS

In the present disclosure, the description of a numerical range of “OO or greater and XX or less” or “OO to XX” denotes a numerical range including the endpoints as the lower limit and the upper limit unless otherwise specified. Further, a toner according to the present disclosure contains toner particles and an external additive for a toner, and “toner particles” will also be referred to as “toner base particles” in the description below. Features of present disclosure

The present inventors have considered the mechanism by which the effects of the present disclosure are exhibited as follows.

As a result of examination conducted by the present inventors, it has been found that an external additive present on an outermost surface layer of an image has a great impact on suppressing scratch scraping. However, hard external additives of the related art, such as inorganic fine particles, are weak against a stress from the outside and thus cannot remain in the place, and therefore, the image is difficult to stably protect.

Further, as a result of intensive examination conducted by the present inventors, it has been found that the above-described disadvantages can be solved by allowing the toner base particles to contain crystalline polyester, optimizing the structure serving as a binder of the external additive, and allowing inorganic fine particles with a specific particle diameter to be present on the surface layer of binder particles so that the embedding degree is optimized, thereby completing the present disclosure. This mechanism is not clear, but it is considered that in a case where inorganic fine particles with a specific particle diameter are allowed to be present on the surface layer of the binder particles of the external additive, the contact with the surface layer due to a stress from the outside can be suppressed. Further, the stress from the outside can be relaxed by introducing a large amount of an alkyl group to the binder component so that moderate flexibility can be imparted to the binder component. Further, it is assumed that scratch resistance can be improved because the external additive can uniformly remain on the image due to an interaction between a straight-chain hydrocarbon chain of the crystalline polyester in the toner and the alkyl group serving as the binder component.

In addition, the term “abrasion resistance” denotes suppression of peeling off of a fixed image due to a frictional force generated between the image and another paper or the like, and the term “scratch resistance” denotes suppression of peeling off of a fixed image due to a strong stress generated by the contact between a sharp object and the image. In the examples described below, each of the properties is specifically evaluated.

### Composite Particles

Hereinafter, the configuration and the production method of composite particles according to the present disclosure will be described in detail.

The composite particles of the present disclosure are formed such that Pa is the proportion of a silicon atom represented by Si^{a} in a structure represented by the following unit (a), Pb is the proportion of a silicon atom represented by Si^{b} in a structure represented by the following unit (b), Pc is the proportion of a silicon atom represented by Si^{c} in a structure represented by the following unit (c) based on all silicon atoms contained in an organic silicon compound of fine particles A containing the organic silicon compound as a binder component, and Pa, Pb, and Pc satisfy Expressions (1) to (3).

$$\begin{matrix}( 1 ) P a + P b + P c \geq 0.80 \\ ( 2 ) Pb + Pc \geq 0.30 \\ ( 3 ) P a / ( P a + Pb + Pc ) \leq 0.7\end{matrix}$$

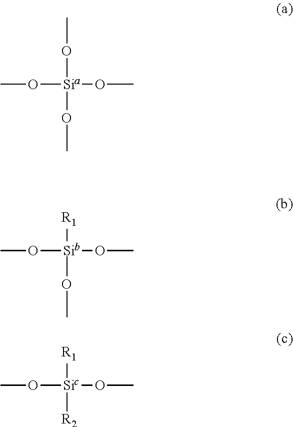

R₁ and R₂ represent an alkyl group having 1 or more and 6 or less carbon atoms.

In a case where the values are in the above-described ranges, since the fine particles A have moderate elasticity, the stress from the outside is relaxed so that the surface layer of the image can be protected, and thus the scratch resistance is improved. Further, since the fine particles A are unlikely to be destroyed, the organic silicon compound functions as a binder component for fine particles B, and the initial embedded state of the fine particles B can also be maintained. In addition, Pa, Pb, and Pc can be controlled by adjusting the amount of a silane monomer having each unit structure to be added.

The fine particles B in the composite particles of the present disclosure are inorganic fine particles, and the number average particle diameter of primary particles is 0.01 μm or greater and 0.06 μm or less. In a case where the number average particle diameter thereof is in the above-described range, since the stress from the outside due to the contact can be dispersed, the surface layer of the image can be protected, and the scratch resistance is improved.

In a case where the number average particle diameter of the primary particles of the fine particles B is less than 0.01 μm, the stress from the outside cannot be dispersed, and thus the effects of the present disclosure cannot be obtained. In a case where the number average particle diameter of the primary particles of the fine particles B is greater than 0.06 μm, the contact area due to the stress from the outside increases, and thus the effects of the present disclosure cannot be obtained. The number average particle diameter of the primary particles of the fine particles B is controlled by selecting the fine particles to be added.

The average value of the embedding ratios of the fine particles B in the composite particles of the present disclosure is 30% or greater and 90% or less.

Embedding ratio (%) of fine particle B=(depth of fine particle B embedded in fine particle A/diameter of fine particle B)×100

In a case where the average value of the embedding ratios is in the above-described range, since the stress from the outside due to the contact can be dispersed, the surface layer of the image can be protected, and thus the scratch resistance is improved. The embedding ratio of the fine particles B can be controlled by adjusting the reaction time and the reaction temperature between the monomer and the fine particles B. In a case where the embedding ratio is intended to be decreased, a method of shortening the reaction time between the monomer and the fine particles B or lowering the reaction temperature may be employed. In a case where the embedding ratio is intended to be increased, a method of increasing the reaction time between the monomer and the fine particles B or increasing the reaction temperature may be employed. The embedding ratio thereof is preferably 40% or greater and 80% or less and more preferably 45% or greater and 70% or less.

The number average particle diameter of the primary particles of the composite particles according to the present disclosure is preferably 0.02 μm or greater and 0.30 μm or less. In a case where the number average particle diameter of the primary particles is in the above-described range, since the image can be uniformly protected, the effect of improving the scratch resistance is likely to be obtained. In a case where the number average particle diameter of the primary particles of the fine particles is less than 0.02 μm, since the spacer effect decreases, the effect of the scratch resistance is unlikely to be obtained. Further, in a case where the number average particle diameter of the primary particles is greater than 0.30 μm, there is a possibility that the composite particles are easily desorbed from the surface layer of the image. The number average particle diameter of the primary particles of the composite particles can be increased by lowering the reaction temperature, shortening the reaction time, or increasing the amount of a catalyst in hydrolysis and condensation steps. Further, the number average particle diameter of the primary particles of the fine particles can be decreased by increasing the reaction temperature, increasing the reaction time, or reducing the amount of a catalyst in the hydrolysis and condensation steps.

The number average particle diameter of the primary particles of the composite particles is more preferably 0.07 μm or greater and 0.20 μm or less and still more preferably 0.08 μm or greater and 0.15 μm or less from the above-described viewpoints.

The Young's modulus of the composite particles according to the present disclosure is preferably 10 GPa or greater and 30 GPa or less. In a case where the Young's modulus thereof is in the above-described range, since the stress from the outside due to the contact can be relaxed, the surface layer of the image can be protected, and the scratch resistance is improved.

The Young's modulus of the composite particles can be controlled by changing the mixing ratio of the alkoxysilane of the structures represented by the units (a) to (c), the temperature, the time, the pH, and the kind of the catalyst in the hydrolysis step and the condensation step. For example, in a case where the Young's modulus thereof is intended to be increased, a method of increasing the mixing ratio of the alkoxysilane having the structure represented by the unit (a), decreasing the mixing ratio of the alkoxysilane having the structures represented by the unit (b) and the unit (c), increasing the temperature in the hydrolysis step and the condensation step, increasing the time in the hydrolysis step and the condensation step, or increasing the pH in the hydrolysis step and the condensation step may be employed. In a case where the Young's modulus thereof is intended to be decreased, a method of decreasing the mixing ratio of the alkoxysilane having the structure represented by the unit (a), increasing the mixing ratio of the alkoxysilane having the structures represented by the unit (b) and the unit (c), decreasing the temperature in the hydrolysis step and the condensation step, decreasing the time in the hydrolysis step and the condensation step, or decreasing the pH in the hydrolysis step and the condensation step may be employed. The Young's modulus of the composite particles is more preferably 13 GPa or greater and 20 GPa or less.

The fine particles B in the composite particles according to the present disclosure have a Young's modulus of preferably 50 GPa or greater and 200 GPa or less. In a case where the Young's modulus thereof is in the above-described range, since the stress from the outside due to the contact can be relaxed, the surface layer of the image can be protected, and thus the scratch resistance is improved.

### Production Method

The method of producing the composite particles according to the present disclosure is not particularly limited, but the composite particles can be formed by performing hydrolysis and a polycondensation reaction on a silicon compound (silane monomer) using a sol-gel method. Specifically, the composite particles can be formed by hydrolyzing and polycondensing a mixture of bifunctional silane having two siloxane bonds with tetrafunctional silane having four siloxane bonds and reacting the mixture with colloidal silica or the like equivalent to the fine particles B. The silane monomer such as the bifunctional silane or the tetrafunctional silane will be described below. The proportion of the bifunctional silane is preferably 30% by mole or greater and 70% by mole or less and more preferably 40% by mole or greater and 60% by mole or less. The proportion of the tetrafunctional silane is preferably 30% by mole or greater and 80% by mole or less and more preferably 40% by mole or greater and 70% by mole or less.

The composite particles according to the present disclosure mainly include particles (fine particles A) that contain, as a binder, a silicon compound having a siloxane bond.

A method of producing the silicon compound is not particularly limited, and for example, the silicon compound can be obtained by adding a silane compound dropwise to water to carry out hydrolysis and the condensation reaction using a catalyst, and filtering and drying the obtained suspension. The particle diameter can be controlled by adjusting the kind of the catalyst, the blending ratio thereof, the reaction start time, the dropping time, and the like. Examples of the catalyst include an acidic catalyst such as hydrochloric acid, hydrofluoric acid, sulfuric acid, or nitric acid, and a basic catalyst such as ammonia water, sodium hydroxide, or potassium hydroxide, but the present disclosure is not limited thereto.

The silicon compound can be produced by the following method. Specifically, the method may include a first step of obtaining a hydrolyzate of a silicon compound, a second step of mixing the hydrolyzate, an alkaline aqueous medium, and colloidal silica to cause a polycondensation reaction of the hydrolyzate so that the hydrolyzate reacts with colloidal silica, and a third step of mixing the polycondensation reactant with an aqueous solution to form particles. In some cases, a hydrophobizing agent may be further blended into the mixture.

In the first step, a silicon compound and a catalyst are brought into contact with each other by, for example, a method of stirring or mixing the silicon compound and the catalyst in an aqueous solution obtained by dissolving an acidic or alkaline substance serving as a catalyst in water. A known catalyst can be suitably used as the catalyst. Specific examples of the catalyst include an acidic catalyst such as acetic acid, hydrochloric acid, hydrofluoric acid, sulfuric acid, or nitric acid, and a basic catalyst such as ammonia water, sodium hydroxide, or potassium hydroxide.

The amount of the catalyst to be used may be appropriately adjusted according to the kinds of the silicon compound and the catalyst. The amount thereof can be adjusted to be in a range of 1×10⁻³ parts by mass or greater and 1 part by mass or less with respect to 100 parts by mass of the amount of water used in a case of hydrolyzing the silicon compound.

In a case where the amount of the catalyst to be used is 1×10⁻³ parts by mass or greater, the reaction sufficiently proceeds. Meanwhile, in a case where the amount of the catalyst to be used is 1 part by mass or less, the concentration of the catalyst remaining as impurities in the fine particles is decreased, and thus the hydrolysis is easily carried out. The amount of water to be used is preferably 2 moles or greater and 15 moles or less with respect to 1 mole of the silicon compound. The hydrolysis reaction sufficiently proceeds in a case where the amount of water is 2 moles or greater, and the productivity is improved in a case where the amount of water is 15 moles or less.

The reaction temperature is not particularly limited, and the reaction may be carried out at room temperature or in a heated state, but the reaction can be carried out in a state where the temperature is maintained at 10° C. to 60° C. from the viewpoint of obtaining a hydrolyzate in a short time and suppressing a partial condensation reaction of the generated hydrolyzate. The reaction time is not particularly limited, and may be appropriately selected in consideration of the reactivity of the silicon compound to be used, the composition of a reaction solution obtained by compounding the silicon compound, an acid, and water, and the productivity.

In a method of producing silicon polymer particles, the raw material solution obtained in the first step described above is mixed with an alkaline aqueous medium to cause a polycondensation reaction of a particle precursor in a second step. In this manner, a polycondensation reaction solution is obtained. Here, the alkaline aqueous medium is a liquid obtained by mixing an alkaline component, water, and as necessary, an organic solvent.

The alkaline component used in the alkaline aqueous medium is a component in which the aqueous solution thereof exhibits basicity and which functions as a neutralizing agent of the catalyst used in the first step and also functions as the catalyst of the polycondensation reaction in the second step. Examples of such an alkaline component include an alkali metal hydroxide such as lithium hydroxide, sodium hydroxide, or potassium hydroxide, ammonia, and organic amines such as monomethylamine and dimethylamine.

The amount of the alkaline component to be used is an amount thereof used to neutralize an acid and effectively function as a catalyst of the polycondensation reaction, and for example, in a case where ammonia is used as the alkaline component, the amount thereof is selected to be in a range of typically 0.01 parts by mass or greater and 12.5 parts by mass or less with respect to 100 parts by mass of a mixture of water and an organic solvent.

In the second step, an organic solvent may be further used in addition to the alkaline component and water in order to prepare the alkaline aqueous medium. The organic solvent is not particularly limited as long as the organic solvent is compatible with water, but an organic solvent that dissolves 10 g or greater of water per 100 g of the organic solvent at room temperature under normal pressure is suitable.

Specific examples of the organic solvent include alcohol such as methanol, ethanol, n-propanol, 2-propanol, or butanol, polyhydric alcohol such as ethylene glycol, diethylene glycol, propylene glycol, glycerin, trimethylolpropane, or hexanetriol, ether such as ethylene glycol monoethyl ether, acetone, diethyl ether, tetrahydrofuran, or diacetone alcohol, and an amide compound such as dimethylformamide, dimethylactamide, or N-methylpyrrolidone.

Among the organic solvents described above, an alcohol-based solvent such as methanol, ethanol, 2-propanol, or butanol is preferable. Further, from the viewpoints of the hydrolysis and the dehydration condensation reaction, it is more preferable to select the same alcohol as the alcohol generated by desorption as the organic solvent.

In a third step, the polycondensation reactant obtained in the second step is mixed with an aqueous solution to form particles. Water (tap water, pure water, or the like) can be suitably used as the aqueous solution, and a component that is compatible with water, such as a salt, an acid, an alkali, an organic solvent, a surfactant, or a water-soluble polymer, may be further added to water. The temperature of the polycondensation reaction solution and the aqueous solution when mixed is not particularly limited, and is suitably selected to be in a range of 5° C. to 70° C. in consideration of the compositions thereof, the productivity, and the like.

A known method can be used without particular limitation as a method of recovering particles. Examples of such a method include a method of scooping floating powder and a filtration method. Among these, a filtration method is preferable from the viewpoint of a simple operation. The filtration method is not particularly limited, and vacuum filtration, centrifugal filtration, pressure filtration, or the like may be performed by selecting a known device. The filter paper, the filter, the filter cloth, and the like used in the filtration are not particularly limited as long as these are industrially available, and may be appropriately selected depending on the device to be used.

The monomer to be used can be appropriately selected depending on the compatibility with the solvent and the catalyst, the hydrolyzability, and the like. Examples of the tetrafunctional silane monomer having the structure represented by the unit (a) include tetramethoxysilane, tetraethoxysilane, and tetraisocyanatosilane. Among these, tetraethoxysilane is preferable.

Examples of the trifunctional silane monomer having the structure represented by the unit (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these, methyltrimethoxysilane is preferable.

Examples of the bifunctional silane monomer having the structure represented by the unit (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. Among these, dimethyldimethoxysilane is preferable.

### Other Physical Properties

The true specific gravity of the composite particles according to the present disclosure is preferably 1.00 g/cm³ or greater and 1.60 g/cm³ or less. In a case where the true specific gravity thereof is in the above-described range, the stress from the outside due to the contact can be relaxed, the composite particles can remain, and thus the surface layer of the image can be protected. Therefore, the scratch resistance is improved. The true specific gravity of the composite particles can be controlled by adjusting the amount of the fine particles B to be added. The true specific gravity of the composite particles is more preferably 1.20 g/cm³ or greater and 1.40 g/cm³ or less.

The Brunauer-Emmett-Teller (BET) specific surface area of the composite particles according to the present disclosure is preferably 70 m²/g or greater and 250 m²/g or less. In a case where the BET specific surface area thereof is in the above-described range, since the stress from the outside due to the contact can be relaxed and the composite particles can remain, the surface layer of the image can be protected, and the scratch resistance is improved. The BET specific surface area of the composite particles can be controlled by adjusting the amount of the fine particles B to be added. The BET specific surface area of the composite particles is more preferably 80 m²/g or greater and 160 m²/g or less.

The fine particles B in the composite particles of the present disclosure can be silica fine particles or alumina fine particles. From the viewpoint of the scratch resistance, the fine particles B can be the above-described fine particles because the fine particles have moderate hardness. Further, from the viewpoint of the reactivity with the binder component, silica fine particles are more preferable. The silica fine particles used in the present disclosure are particles containing silica (that is, SiO₂) as a main component and may be particles produced by using a silicon compound such as water glass or alkoxysilane as a raw material or particles obtained by pulverizing quartz.

Specific examples thereof include silica particles prepared by a sol-gel method, precipitated silica particles prepared by a precipitation method, aqueous colloidal silica particles, fumed silica particles obtained by a gas phase method, and fused silica particles. Among these, from the viewpoints of the reactivity with the above-described binder component and the dispersion stability, aqueous colloidal silica particles are preferable. The aqueous colloidal silica particles are commercially available or can be prepared from various starting materials by a known method. The aqueous colloidal silica particles can be prepared from silicic acid derived from an alkali silicate solution having a pH of about 9 to 11, and silicate anions undergo polymerization to generate silica particles having a desired average particle diameter in the form of an aqueous dispersion liquid.

The surface of the composite particles according to the present disclosure can be subjected to a surface treatment using a hydrophobic treatment agent. The hydrophobic treatment agent is not particularly limited, but an organic silicon compound is preferable. Examples thereof include an alkylsilazane compound such as hexamethyldisilazane, an alkylalkoxysilane compound such as diethyldiethoxysilane, trimethylmethoxysilane, methyltrimethoxysilane, or butyltrimethoxysilane, a fluoroalkylsilane compound such as trifluoropropyltrimethoxysilane, a chlorosilane compound such as dimethyldichlorosilane or trimethylchlorosilane, a siloxane compound such as octamethylcyclotetrasiloxane, silicone oil, and silicone varnish.

The effect of the scratch resistance is improved by the hydrophobic treatment performed on the surface of the composite particles. Among the above-described examples, the fine particles can be subjected to a surface treatment with at least one compound selected from the group consisting of an alkylsilazane compound, an alkylalkoxysilane compound, a chlorosilane compound, a siloxane compound, and silicone oil. Further, the composite particles can be subjected to a surface treatment with an alkylsilazane compound from the above-described viewpoint.

Pa, Pb, and Pc of the composite particles according to the present disclosure in the fine particles A may satisfy Expressions (I), (II), and (III).

$$0.3 \leq P a / ( P a + P b + P c ) \leq 0.8 \qquad ( I )$$

$$0 \leq Pb / ( P a + P b + P c ) \leq 0.50 \qquad ( II )$$

$$0.2 \leq Pc / ( P a + P b + P c ) \leq 0 \text{.70} \qquad ( III )$$

In a case where the values are in the above-described ranges, since the fine particles A have moderate elasticity, the stress from the outside is relaxed so that the surface layer of the image can be protected, and thus the scratch resistance is improved. Further, since the fine particles A are unlikely to be destroyed, the organic silicon compound functions as a binder component for fine particles B, and the initial embedded state of the fine particles B can be maintained.

In addition, Pa, Pb, and Pc can be controlled by adjusting the amount of a silane monomer having each unit structure to be added.

Further, from the above-described viewpoint, 0.40≤Pa/(Pa+Pb+Pc)≤0.60, 0 23 Pb/(Pa+Pb+Pc)≤0.10, and 0.30≤Pc/(Pa+Pb+Pc)≤0.70 may be satisfied.

The content of the composite particles according to the present disclosure is preferably 0.1 parts by mass or greater and 20.0 parts by mass or less, more preferably 0.5 parts by mass or greater and 15.0 parts by mass or less, and still more preferably 1.0 parts by mass or greater and 10.0 parts by mass or less with respect to 100 parts by mass of the toner base particles.

In a case where the content of the composite particles is less than 0.1 parts by mass, since the amount of the composite particles present on the image is extremely small, the effects of the present disclosure are unlikely to be obtained. Further, in a case where the content of the composite particles is greater than 20.0 parts by mass, the low-temperature fixability of the toner may be impaired.

### Toner Particles

Next, the configuration of the toner particles to which the composite particles according to the present disclosure are externally added will be described in detail.

### Binder Resin

The binder resin used in the toner according to the present disclosure is not particularly limited, and the following polymer or resin can be used as the binder resin.

Examples of the binder resin include homopolymers of styrene and substituents thereof, such as poly-p-chlorostyrene and polyvinyltoluene; styrene-based copolymers such as a styrene-p-chlorostyrene copolymer, a styrene-vinyltoluene copolymer, a styrene-vinylnaphthalene copolymer, a styrene-acrylic acid ester copolymer, a styrene-methacrylic acid ester copolymer, a styrene-α-methyl chloromethacrylate copolymer, a styrene-acrylonitrile copolymer, a styrene-vinyl methyl ether copolymer, a styrene-vinyl ethyl ether copolymer, a styrene-vinyl methyl ketone copolymer, and a styrene-acrylonitrile-indene copolymer; polyvinyl chloride, a phenol resin, a naturally modified phenol resin, a natural resin-modified maleic acid resin, an acrylic resin, a methacrylic resin, polyvinyl acetate, a silicone resin, a polyester resin, polyurethane, a polyamide resin, a furan resin, an epoxy resin, a xylene resin, polyvinyl butyral, a terpene resin, a coumarone-indene resin, and a petroleum-based resin. Among these, from the viewpoints of durable stability and charging stability, a polyester resin is preferable.

Further, the acid value of the polyester resin is preferably 0.5 mgKOH/g or greater and 40 mgKOH/g or less from the viewpoints of environmental stability and the charging stability. The acid value in the polyester resin and Si—CH₃ in the fine particles interact with each other, and as a result, the durability and the toner chargeability in a high-temperature high-humidity environment can be further improved. The acid value thereof is more preferably 1 mgKOH/g or greater and 20 mgKOH/g or less and still more preferably 1 mgKOH/g or greater and 15 mgKOH/g or less.

### Crystalline Polyester

The toner according to the present disclosure contains crystalline polyester. Among examples, the toner may contain a monomer having a straight-chain hydrocarbon chain with 8 or more and 12 or less carbon atoms. In a case where the straight-chain hydrocarbon chain of the crystalline polyester has 8 or more and 12 or less carbon atoms, since the crystalline polyester easily interacts with the alkyl group of the composite particles, the adhesiveness between the composite particles and the toner layer is improved, and thus the scratch resistance is improved.

Examples of the monomer having a straight-chain hydrocarbon chain with 8 or more and 12 or less carbon atoms include alcohol components (the number of C's described below denotes the number of carbon atoms of the straight-chain hydrocarbon chain) such as 1,8-octanediol (C8), 1,9-nonanediol (C9), 1,10-decanediol (C10), 1,11-undecanediol (C11), and 1,12-dodecanediol (C12); and carboxylic acid components (the number of C's described below denotes the number of carbon atoms of the straight-chain hydrocarbon chain) such as sebacic acid (C8), 1,9-nonanedicarboxylic acid (C9), 1,10-decanedicarboxylic acid (C10), and 1,12-dodecanedicarboxylic acid (C12).

In the present disclosure, the content of the above-described monomer component having a straight-chain hydrocarbon chain in the crystalline polyester is preferably 40% by mole or greater.

Examples of other monomer components contained in the crystalline polyester include alcohol components, for example, aromatic diols such as ethylene glycol, 1,3-propanediol, 1,4-butanediol, 1,5-pentanediol, 1,6-hexanediol, 1,7-heptanediol, 1,13-tridecanediol, 1,14-tetradecanediol, 1,18-octadecanediol, 1,20-icosanediol, a polyoxypropylene adduct of 2,2-bis(4-hydroxyphenyl)propane, and an alkylene oxide adduct of bisphenol A containing a polyoxyethylene adduct of 2,2-bis(4-hydroxyphenyl)propane, glycerin, pentaerythritol, and trimethylolpropane; and carboxylic acid components such as oxalic acid, succinic acid, glutaric acid, adipic acid, suberic acid, azelaic acid, 1,14-tetradecanedicarboxylic acid, and 1,18-octadecanedicarboxylic acid; anhydrides thereof, and lower alkyl esters thereof. Examples of the alkyl group in the lower alkyl ester include a methyl group, an ethyl group, a propylene group, and an isopropyl group.

Among combinations of these components, from the viewpoints of the low-temperature fixability and the scratch resistance, crystalline polyester containing 40% by mole or greater of 1,10-decanedicarboxylic acid is preferable, and crystalline polyester containing 40% by mole or greater of 1,10-decanedicarboxylic acid and 40% by mole or greater of 1,6-hexanediol is more preferable. In a case where crystalline polyester having such a configuration is used, the compatibility between the crystalline polyester and other binder resins constituting the toner base particles is increased so that the crystalline polyester can be uniformly present in the toner base particles, the composite particles can be uniformly maintained on the surface of the image, and thus the scratch resistance is enhanced.

The weight-average molecular weight of the crystalline polyester is preferably 1.0×10⁴ or greater and 1.0×10⁵ or less and more preferably 2.0×10⁴ or greater and 5.0×10⁴ or less. Further, the melting point of the crystalline polyester is preferably 60° C. or higher and 85° C. or lower and more preferably 62° C. or higher and 73° C. or lower.

In a case where the weight-average molecular weight and the melting point of the crystalline polyester are in the above-described ranges, the plasticizing effect for the binder resin is exhibited during fixation, and thus the low-temperature fixability is further enhanced.

The content of the crystalline polyester in the toner according to the present disclosure is preferably 1.0 parts by mass or greater and 15.0 parts by mass or less and more preferably 3.0 parts by mass or greater and 15.0 parts by mass or less with respect to 100 parts by mass of the binder resin.

The content of the crystalline polyester may be in the above-described ranges from the viewpoint that the plasticizing effect can be effectively obtained during fixation, the low-temperature fixability is further enhanced, the frequency of the interaction between the alkyl group of the composite particles and the ester group of the crystalline polyester is increased, and thus the scratch resistance can be improved.

### Colorant

The toner according to the present disclosure may use a colorant as necessary. Examples of the colorant will be described below.

Examples of a black colorant include carbon black; and a colorant toned to black using a yellow colorant, a magenta colorant, and a cyan colorant. A pigment may be used alone in the colorant, but a colorant obtained by combining a dye and a pigment with improved sharpness is more preferable from the viewpoint of the image quality of a full-color image.

Examples of a pigment for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; C.I. Violet 1, 2, 10, 13, 15, 23, 29, and 35.

Examples of a dye for a magenta toner include C.I. Solvent Red 1, 3, 8, 23, 24, 25, 27, 30, 49, 81, 82, 83, 84, 100, 109, and 121; C.I. disperse Red 9; C.I. Solvent Violet 8, 13, 14, 21, and 27; an oil-soluble dye such as C.I. Disperse Violet 1, C.I. Basic Red 1, 2, 9, 12, 13, 14, 15, 17, 18, 22, 23, 24, 27, 29, 32, 34, 35, 36, 37, 38, 39, and 40; and a basic dye such as C.I. Basic Violet 1, 3, 7, 10, 14, 15, 21, 25, 26, 27, and 28.

Examples of a pigment for a cyan toner include C.I. Pigment Blue 2, 3, 15:2, 15:3, 15:4, 16, and 17; C.I. Vat Blue 6; C.I. Acid Blue 45, and a copper phthalocyanine pigment in which 1 to 5 phthalimidomethyl groups are substituted with a phthalocyanine skeleton.

Examples of a dye for a cyan toner include C.I. Solvent Blue 70.

Examples of a pigment for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of a dye for a yellow toner include C.I. Solvent Yellow 162.

The content of the colorant is preferably 0.1 parts by mass or greater and 30.0 parts by mass or less with respect to 100 parts by mass of the binder resin.

### Wax

The toner according to the present disclosure may use wax as necessary. Examples of the wax include hydrocarbon-based wax such as microcrystalline wax, paraffin wax, or Fischer Tropsch; an oxide of hydrocarbon-based wax such as oxidized polyethylene wax or a block copolymer thereof; waxes containing fatty acid ester as a main component, such as carnauba wax; and waxes obtained by partially or entirely deoxidizing fatty acid esters, such as deoxidized carnauba wax.

Other examples of the wax include straight-chain saturated fatty acids such as palmitic acid, stearic acid, and montanoic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; esters of fatty acids such as palmitic acid, stearic acid, behenic acid, and montanoic acid with alcohols such as stearyl alcohol, aralkyl alcohol, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bisoleic acid amide, hexamethylene bisoleic acid amide, N,N′-dioleyl adipic acid amide, and N,N′-dioleyl sebacic acid amide, aromatic bisamides such as m-xylene bisstearic acid amide and N,N′-distearyl isophthalic acid amide; aliphatic metal salts (commonly known as metallic soap) such as calcium stearate, calcium laurate, zinc stearate, and magnesium stearate; waxes grafted to aliphatic hydrocarbon-based wax using a vinyl-based monomer such as styrene or acrylic acid; a partially esterified substance of polyhydric alcohol and fatty acids such as behenic acid monoglyceride; and a methyl ester compound containing a hydroxyl group obtained by hydrogenating vegetable fats and oils.

The content of the wax is preferably 2.0 parts by mass or greater and 30.0 parts by mass or less with respect to 100 parts by mass of the binder resin.

### Charge Control Agent

The toner according to the present disclosure can also contain a charge control agent as necessary. A known charge control agent can be used as the charge control agent contained in the toner, but a metal compound of an aromatic carboxylic acid which is colorless, has a high charging speed, and stably maintains a constant charge amount is particularly preferable.

Examples of a negative charge control agent include a salicylic acid metal compound, a naphthoic acid metal compound, a dicarboxylic acid metal compound, a polymer type compound having sulfonic acid or a carboxylic acid in a side chain, a polymer type compound having a sulfonate or a sulfonic acid esterified substance in a side chain, a polymer type compound having a carboxylate or a carboxylic acid esterified substance in a side chain, a boron compound, a urea compound, a silicon compound, and a calixarene. The charge control agent may be added internally or externally to the toner particles.

The amount of the charge control agent to be added is preferably 0.2 parts by mass or greater and 10.0 parts by mass or less with respect to 100 parts by mass of the binder resin.

### Inorganic Fine Powder

A combination of other inorganic fine powders can also be used as necessary in the toner according to the present disclosure in addition to the above-described external additive for a toner. The inorganic fine powder may be internally added to the toner particles or may be mixed with the toner base particles as the external additive. Inorganic fine powder such as silica is preferable as the external additive. The inorganic fine powder can be hydrophobized with a hydrophobizing agent such as a silane compound, silicone oil, or a mixture thereof.

Inorganic fine powder having a specific surface area of 50 m²/g or greater and 400 m²/g or less is preferable as the external additive for improving the flowability. Inorganic fine powders having the specific surface areas in the above-described range may also be used in combination in order to achieve both improvement of the flowability and stabilization of the durability. The content of the inorganic fine powder is preferably 0.1 parts by mass or greater and 10.0 parts by mass or less with respect to 100 parts by mass of the toner particles. In a case where the content thereof is in the above-described range, the effect of durable stability is likely to be obtained.

### Developer

The toner according to the present disclosure can be used as a one-component developer, but the toner can be mixed with a magnetic carrier and used as a two-component developer in order to further improve dot reproducibility from the viewpoint of obtaining an image stabilized over a long period of time. That is, the two-component developer may contain a toner and a magnetic carrier, and the toner may be the toner according to the present disclosure.

Examples of the magnetic carrier include commonly known magnetic carriers such as surface-oxidized iron powder, unoxidized iron powder, metal particles such as iron, lithium, calcium, magnesium, nickel, copper, zinc, cobalt, manganese, chromium, and rare earth elements, alloy particles thereof, oxide particles, a magnetic material such as ferrite, and a magnetic material-dispersed resin carrier (so-called resin carrier) containing a magnetic substance and a binder resin that maintains the magnetic material in a dispersed state.

In a case where the toner is mixed with the magnetic carrier and used as a two-component developer, usually satisfactory results can be obtained when the mixing ratio of the carrier is set to preferably 2% by mass or greater and 15% by mass or less and more preferably 4% by mass or greater and 13% by mass or less with respect to the concentration of the toner in the two-component developer.

### Method of Producing Toner Particles and Method of Producing Toner

A method of producing the toner particles is not particularly limited, and a known production method of the related art, such as a suspension polymerization method, an emulsion aggregation method, a melt kneading method, or a dissolution suspension method, can be employed.

The toner may be obtained by mixing the obtained toner particles with composite particles and, as necessary, other external additives. The toner particles can be mixed with the composite particles and other external additives by using a mixing device such as a double cone mixer, a V-type mixer, a drum type mixer, a super mixer, a Henschel mixer, a Nauta mixer, Mechano Hybrid (manufactured by NIPPON COKE & ENGINEERING CO., LTD.), or NOBILTA (manufactured by Hosokawa Micron Corporation).

### Method of Measuring Various Physical Properties

Methods of measuring various physical properties will be described below. Separation of external additives and toner particles from toner

Each physical property can be measured by using the external additives separated from the toner by the following method. 200 g of sucrose (manufactured by Kishida Chemical Co., Ltd.) is added to 100 mL of ion exchange water and dissolved in a hot water bath to prepare a concentrated sucrose solution. 31 g of the concentrated sucrose liquid and 6 mL of Contaminon N (10 mass % aqueous solution for a neutral detergent for cleaning a precision measuring instrument, which consists of a nonionic surfactant, an anionic surfactant, and an organic builder and has a pH of 7, manufactured by FUJIFILM Wako Pure Chemical Corporation) are placed in a centrifuge tube to prepare a dispersion liquid. 1 g of the toner is added to the dispersion liquid, and toner clumps are loosened with a spatula or the like.

The centrifuge tube is shaken in a shaker for 20 minutes under a condition of reciprocation performed 350 times per minute. After the shaking, the solution is transferred to a glass tube (50 mL) for a swing rotor and centrifuged by a centrifuge under conditions of 3500 rpm for 30 minutes. In the glass tube after the centrifugation, the toner is present on the uppermost layer, and the external additive is present on the underlayer on the aqueous solution side. The aqueous solution on the underlayer is collected and centrifuged to separate the sucrose and the external additive, and the external additive is collected. The centrifugation is repeatedly performed as necessary to sufficiently carry out the separation, the dispersion liquid is dried, and the external additive is collected.

In a case where a plurality of external additives are added, the composite particles according to the present disclosure can be sorted out by using a centrifugal separation method or the like.

### Method of Measuring Number Average Particle Diameter of Primary Particles of Composite Particles

The number average particle diameter of the primary particles of the composite particles can be determined by performing measurement using a centrifugal sedimentation method.

Specifically, 0.01 g of the dried composite particles are put into a 25 mL glass vial, and a solution is prepared by adding 0.2 g of a 5% triton solution and 19.8 g of RO water to the particles. Next, a probe (tip inside the tip) of an ultrasonic disperser is immersed in the solution and subjected to ultrasonic dispersion at an output of 20 W for 15 minutes, thereby obtaining a dispersion liquid. Subsequently, the number average particle diameter of the primary particles is measured using this dispersion liquid by a centrifugal sedimentation particle size distribution measuring device DC24000 (manufactured by CPS Instruments, Inc.). The rotation speed of a disk is set to 18000 rpm, and the true density is set to 1.35 g/cm³. Before the measurement, the device is subjected to calibration using polyvinyl chloride particles having an average particle diameter of 0.476 μm.

### Method of Measuring Young's Modulus of Composite Particles

The Young's modulus of the composite particles is determined by a microcompression test performed using a Hysitron PI 85L Picoindenter (manufactured by BRUKER). The Young's modulus (MPa) is calculated from the inclination of the profile (load-displacement curve) of the displacement (nm) and the test force (μN) obtained by the measurement.
Device and jig
   Base system: Hysitron PI-85L
   Measurement indenter: circular flat end indenter with diameter of 1 μm
   SEM used: Thermo Fisher Versa 3D
   Conditions for SEM: −10° tilt, 13 pA at 10 keV
Measurement conditions
   Measurement mode: displacement control
   Maximum displacement: 30 nm
   Displacement speed: 1 nm/sec
   Retention time: 2 seconds
   Unloading speed: 5 nm/sec
Analysis method

Hertz analysis is applied to a curve in a case of compressing the obtained load-displacement curve by 0 nm to 10 nm, and the Young's modulus of the fine particles is calculated.
Sample adjustment

A sample is prepared by attaching fine particles onto a silicon wafer.

### Method of Measuring Young's Modulus of Fine Particles B

First, the composition of the fine particles B is identified. The measurement is performed using a scanning electron microscope “S-4800” (trade name, manufactured by Hitachi, Ltd.). An external additive in which a difference in contrast of an image occurs between a site derived from the fine particles B as an inorganic substance and a site derived from the fine particles A as an organic substance is defined as the external additive for the toner according to the present disclosure, and an external additive in which the difference in contrast has not occurred is defined as an external additive other than the external additive for the toner according to the present disclosure. Further, the fine particles B as an inorganic substance are observed to have a higher brightness. The external additives are observed, and the compositions of the fine particles A and the fine particles B are identified with an energy dispersive X-ray analyzer in a visual field magnified up to a maximum of 2000000 times. The composition of the fine particles B is identified, fine particles having the same composition as the composition of the fine particles B are prepared, the Young's modulus of the fine particles is measured in the same manner as the measurement of the Young's modulus of the external additive described above, and the obtained value is defined as the Young's modulus of the fine particles B.

### Method of Measuring Embedding Ratio of Fine Particles B

The external additive is sufficiently dispersed in a visible light-curable resin (trade name, ARONIX LCR Series D-800, manufactured by TOAGOSEI CO., LTD.), and the resin is irradiated with short-wavelength light and cured. The obtained cured substance is cut out using an ultramicrotome provided with a diamond knife to prepare a flaky sample with a size of 250 nm. Next, the cut-out sample is magnified at a magnification of 40000 times to 50000 times using a transmission electron microscope (electron microscope JEM-2800, manufactured by JEOL Ltd.) (TEM-EDX), and a cross section of the external additive is observed. The diameter of the fine particles B and the depth of the fine particles B embedded in the fine particles A are measured from the cross-sectional image. Five fine particles B per particle of the external additive are randomly selected, and the embedding ratio of the fine particles B is calculated according to the following equation. Further, the number of particles of the external additive to be analyzed is set to 20 particles or more, and the average value of the obtained embedding ratios is defined as the embedding ratio of the fine particles B.

Embedding ratio (%) of fine particle B=(depth of fine particle B embedded in fine particle A/diameter of fine particle B)×100

### Method of Measuring Content Proportion of Constituent Compound in Fine Particles a According to Solid-State ²⁹Si-NMR

In the solid-state 29Si-NMR, peaks are detected in different shift regions by the structure of the functional group bonded to Si of the constituent compound of the external additive. The structure bonded to Si can be specified by specifying each peak position using a standard sample. Further, the abundance ratio of each constituent compound can be calculated from the obtained peak area. The ratios of the peak areas of an M unit structure, a D unit structure (c), a T unit structure (b), and a Q unit structure (a) with respect to the entire peak area can be determined by calculation.

Specifically, the measurement conditions for solid-state ²⁹Si-NMR are as follows.
Device: JNM-ECX5002 (JEOL RESONANCE)
Temperature: room temperature
Measuring method: DDMAS method 29Si 45°
Sample tube: zirconia 3.2 mmϕ
Sample: sample tube filled with sample in powder state
Sample rotation speed: 10 kHz
Relaxation delay: 180 s
Scan: 2000

After the measurement, a plurality of silane components of the sample having different substituents and bonding groups are separated into peaks of the following M unit structure, D unit structure (c), T unit structure (b), and Q unit structure (a) by performing curve fitting, and each peak area is calculated.

The curve fitting is performed using EXcalibur for Windows (registered trademark) version 4.2 (EX series) for software for JNM-EX400 (manufactured by JEOL Ltd.). The measurement data is read by clicking “1D Pro” from the menu icons. Next, “Curve fitting function” is selected from “Command” of the menu bar, and curve fitting is performed. The curve fitting for each component is performed such that a difference (synthesized peak difference) between a synthesized peak formed by synthesizing each peak obtained by curve fitting and a peak which is the measurement result is minimized.
M unit structure: (Ra)(Rb)(Rc)SiO_{1/2}
D unit structure: (Rd)(Re)Si(O_{1/2})₂ (c)
T unit structure: RfSi(O_{1/2})₃ (b)
Q unit structure: Si(O_{1/2})₄ (a)

Ra, Rb, Rc, Rd, Re, and Rf in the formulae shown above represent an organic group (for example, an alkyl group or an alkoxy group) such as a hydrocarbon group having 1 or more and 6 or less carbon atoms, which is bonded to silicon, a halogen atom, or a hydroxy group. Pa, Pb, and Pc in the external additive are calculated from the peak area Pa corresponding to the structure represented by Formula (a), the peak area Pb corresponding to the structure represented by Formula (b), and the peak area Pc corresponding to the structure represented by Formula (c), which are obtained by the measurement. Further, in a case where the structures are required to be confirmed in more detail, the measurement results of 13C-NMR and 1H-NMR may be identified along with the measurement results of ²⁹Si-NMR.

### Method of Measuring True Specific Gravity of Composite Particles

The true specific gravity of the composite particles is measured by a dry type automatic densitometer AUTOPYCNOMETER (manufactured by Yuasa Ionics Co., Ltd.). The conditions for the measurement are as follows.
Cell: SM cell (10 ml)
Sample amount: 0.05 g

This measurement method is a method of measuring the true specific gravity of a solid and a liquid using a gas phase substitution method.

Similarly to a liquid phase substitution method, this method is based on Archimedes' principle, but has high precision for micropores because gas (argon gas) is used as a substitution medium.

### Measurement of BET Specific Surface Area of Composite Particles

The BET specific surface area of the composite particles can be determined by a low-temperature gas adsorption method using a dynamic constant pressure method in conformity with a BET method (specifically, a BET multipoint method). The BET specific surface area (m²/g) can be calculated by adsorbing nitrogen gas on the surface of the sample and performing measurement by the BET multipoint method using a specific surface area measuring device (trade name: GEMINI 2375 Ver. 5.0, manufactured by Shimadzu Corporation).

### Method of Measuring Surface Treatment Agent of Composite Particles

A surface treatment agent of the external additive is analyzed by pyrolysis GC-MS (gas chromatography mass spectrometry).

The specific measurement conditions are as follows.
Device: GC6890A (manufactured by Agilent Technologies), pyrolyzer (manufactured by Japan Analytical Industry Co., Ltd.)
Column: HP-5 ms 30 m
Pyrolysis temperature: 590° C.

The surface treatment agent of the external additive is specified by specifying each peak position of the profile obtained by the measurement using a standard sample.

### Method of Measuring Acid Value of Binder Resin

The acid value is the number of milligrams of potassium hydroxide required to neutralize acid components such as free fatty acids and resin acids contained in 1 g of a sample. The acid value is measured in conformity with JIS-K0070-1992 as follows.

### (1) Reagent

1.0 g of phenolphthalein is dissolved in 90 mL of ethyl alcohol (95% by volume), and ion exchange water is added thereto to adjust the amount thereof to 100 mL, thereby obtaining a phenolphthalein solution.

7 g of special grade potassium hydroxide is dissolved in 5 mL of water, and ethyl alcohol (95% by volume) is added thereto to adjust the amount thereof to 1 L. The mixture is placed in an alkali-resistant container to avoid contact with carbon dioxide or the like, allowed to stand for 3 days, and filtered, thereby obtaining a potassium hydroxide solution. The obtained potassium hydroxide solution is stored in the alkali-resistant container. The factor of the potassium hydroxide solution is determined from the amount of the potassium hydroxide solution required for neutralization by placing 25 mL of 0.1 mol/L hydrochloric acid in an Erlenmeyer flask, adding several drops of the phenolphthalein solution thereto, and performing titration with the potassium hydroxide solution. Hydrochloric acid prepared in conformity with JIS K 8001-1998 is used as the 0.1 mol/L hydrochloric acid.

### (2) Operation

### (A) Main Test

2.0 g of a pulverized sample is precisely weighed in a 200 mL Erlenmeyer flask, and 100 mL of a mixed solution of toluene and ethanol (2:1) is added thereto and dissolved therein over 5 hours. Next, several drops of the phenolphthalein solution are added thereto as an indicator, and titration is performed using the potassium hydroxide solution. Further, the end point of the titration is determined as the time point when the pale red color of the indicator is continued for about 30 seconds.

### (B) Blank Test

The titration is performed in the same manner as in the above-described operation except that the sample is not used (that is, only the mixed solution of toluene and ethanol (2:1) is used).

(3) The Obtained Results are Substituted into the Following Equation to Calculate the Acid Value.

$$A = [ ( C - B ) \times f \times 5.61 ] / S$$

Here, A represents the acid value (mgKOH/g), B represents the amount (mL) of the potassium hydroxide solution to be added in the blank test, C represents the amount (mL) of the potassium hydroxide solution to be added in the main test, f represents the factor of the potassium hydroxide solution, and S represents the mass (g) of the sample.

### Measurement of Acid Value of Polyester Resin from Toner

A method of measuring the acid value of the polyester resin from the toner can be performed by using the following method. The polyester resin is separated from the toner using the following method, and the acid value is measured.

The toner is dissolved in tetrahydrofuran (THF), and the solvent is distilled off from the obtained soluble matter under reduced pressure to obtain a tetrahydrofuran (THF) soluble component of the toner.

The tetrahydrofuran (THF) soluble component of the obtained toner is dissolved in chloroform to prepare a sample solution with a concentration of 25 mg/ml.

3.5 ml of the obtained sample solution is injected to the following device, and a resin component with a molecular weight of 2000 or greater is isolated under the following conditions.
Preparative GPC device: manufactured by Japan Analytical Industry Co., Ltd., preparative HPLC LC-980 model
Preparative column: JAIGEL 3H, JAIGEL 5H (manufactured by Japan Analytical Industry Co., Ltd.)
Eluent: chloroform
Flow rate: 3.5 ml/min

A high-molecular-weight component derived from the resin is isolated, the solvent is distilled off under reduced pressure, and the component is dried in an atmosphere of 90° C. for 24 hours under reduced pressure. The operation is repeatedly performed until about 2.0 g of the resin component is obtained.

The acid value is measured using the obtained sample by the following procedures.

### Method of Measuring Weight-Average Particle Diameter (D4) of Toner Particles

The weight-average particle diameter (D4) of the toner particles is calculated by performing measurement with 25000 effective measuring channels using a precision particle size distribution measuring device “Coulter Counter Multisizer 3” (registered trademark, manufactured by Beckman Coulter, Inc.) provided with a 100 μm aperture tube according to an aperture impedance method and dedicated software “Beckman Coulter Multisizer 3 Version 3.51” (manufactured by Beckman Coulter, Inc.) attached to set the measurement conditions and analyze the measurement data and analyzing the measurement data.

An electrolyte aqueous solution obtained by dissolving special grade sodium chloride in ion exchange water so that the concentration thereof reaches about 1% by mass, for example, “ISOTON II” (manufactured by Beckman Coulter, Inc.) can be used for the measurement.

In addition, the dedicated software is set up in the following manner before the measurement and the analysis.

In the dedicated software “screen for changing standard measuring method (SOM)”, the total count number in the control mode is set to 50000 particles, the number of times of measurement is set to once, and a value obtained by using “nominal particle 10.0 μm” (manufactured by Beckman Coulter, Inc.) is set as the Kd value. The threshold value and the noise level are automatically set by pressing the measurement button of the threshold value/noise level. Further, the current is set to 1600 HA, the gain is set to 2, the electrolyte solution is set to ISOTON II, and the aperture tube flash after measurement is checked.

In dedicated software “setting screen for converting pulse to particle diameter”, the bin interval is set to the logarithmic particle diameter, the particle diameter bin is set to 256 particle diameter bin, and the particle diameter range is set to 2 μm or greater and 60 μm or less.

The specific measuring method is as follows.

(1) A 250 ml round-bottom glass beaker for exclusive use of Multisizer 3 is charged with about 200 ml of the electrolyte solution and set on a sample stand, and the solution is stirred with a stirrer rod at 24 rotations/sec in a counterclockwise direction. Further, the stain and air bubbles inside the aperture tube are removed by the dedicated software “aperture tube flash”.
(2) A 100 ml flat-bottom glass beaker is charged with about 30 ml of the electrolyte solution, and about 0.3 ml of a diluent obtained by diluting “Contaminon N” (10 mass % aqueous solution of neutral detergent for cleaning precision measuring instrument with pH of 7, which is formed of nonionic surfactant, anionic surfactant, and organic builder, manufactured by FUJIFILM Wako Pure Chemical Corporation) to 3 times by mass with ion exchange water is added thereto as a dispersant.
(3) A predetermined amount of ion exchange water is placed in a water tank of an ultrasonic disperser “Ultrasonic Dispersion System Tetoral 150” (manufactured by Nikkaki-bios K.K.) with an electrical output of 120 W, which is provided with two built-in oscillators having an oscillation frequency of 50 kHz in a state of a phase shift of 180 degrees, and about 2 ml of Contaminon N is added to the water tank.
(4) The beaker of the item (2) is set in a beaker fixing hole of the ultrasonic disperser, and the ultrasonic disperser is operated. Further, the position of the height of the beaker is adjusted such that the resonance state of the liquid level of the electrolyte solution in the beaker is maximized.
(5) The electrolyte solution in the beaker of the item (4) is irradiated with ultrasonic waves, and about 10 mg of the toner is added to the electrolyte solution little by little and dispersed therein. Further, an ultrasonic dispersion treatment is further continued for 60 seconds. In addition, the water temperature in the water tank is appropriately adjusted to 10° C. or higher and 40° C. or lower in the ultrasonic dispersion treatment.
(6) The electrolyte solution of the item (5) in which the toner has been dispersed using a pipette is added dropwise to the round-bottom beaker of the item (1) disposed in the sample stand, and the measurement concentration is adjusted to about 5%. Further, the measurement is performed until the number of measured particles reaches 50000.
(7) The weight-average particle diameter (D4) is calculated by analyzing the measurement data using the dedicated software attached to a device. Further, “average diameter” of the analysis/volume statistics (arithmetic average) screen is the weight-average particle diameter (D4) in a case where the graph/vol % is set with the dedicated software.

### Measurement of Weight-Average Molecular Weight of Crystalline Polyester

The weight-average molecular weight is measured using gel permeation chromatography (GPC) in the following manner.

First, 50 mg of a sample is placed in 5 mL of chloroform, allowed to stand at 25° C. for several hours, sufficiently shaken so that the sample is mixed well with chloroform, and allowed to stand for 24 hours or longer until no coalescence of the sample remains.

Further, the obtained solution is filtered through a solvent-resistant membrane filter “MYSHORIDISC H-25-5” (manufactured by Tosoh Corporation) having a pore size of 0.5 μm to obtain a sample solution.

The measurement is performed using this sample solution under the following conditions.
Device: high-speed GPC device “Labsolutions GPC” (manufactured by Shimadzu Corporation)
Column: two columns of PLgel 5 μm MIXED-C, 300 mm×7.5 mm (manufactured by Agilent Technologies, Inc.), one column of PLgel 5 μm Guard, 50 mm×7.5 mm (manufactured by Agilent Technologies, Inc.)
Eluent: chloroform
Flow rate: 1.0 ml/min
Oven temperature: 45° C.
Sample injection volume: 60 μL
Detector: refractive index (RI) detector

The weight-average molecular weight (Mw) of the sample is calculated using a molecular weight calibration curve prepared by using standard polystyrene resins (trade names “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation).

### Measurement of Melting Point of Crystalline Polyester

The melting point of the crystalline polyester is measured by the following method.

The melting point is measured using a differential scanning calorimeter (DSC) and MDSC-2920 (manufactured by TA Instruments) under the following conditions in conformity with ASTM D3418-82.

First, about 3 mg of a precisely weighed sample is used as the measurement sample and placed in an aluminum pan, and an empty aluminum pan is used as a reference.

The measurement temperature range is set to 30° C. or higher and 200° C. or lower, first increased to 200° C. from 30° C. at a temperature increase rate of 10° C./min, and then decreased to 30° C. from 200° C. at a temperature decrease rate of 10° C./min.

Thereafter, the temperature is increased again to 200° C. from 30° C. at a temperature increase rate of 10° C./min.

The peak temperature of the maximum endothermic peak in a specific heat change curve obtained in the second process of increasing the temperature is defined as the melting point of the crystalline polyester.

### EXAMPLES

Hereinafter, the present disclosure will be described in more detail with reference to examples. However, the present disclosure is not limited to thereto. In the following formulations, “parts” are on a mass basis unless otherwise specified. Production Example of composite particles 1

### 1. Hydrolysis and Polycondensation Step:

(1) A 500 ml beaker was charged with 21.6 g of RO water, 135.0 g of methanol, 0.004 g of acetic acid as a catalyst, and 12.2 g of dimethyldimethoxysilane, and the mixture was stirred at 45° C. for 5 minutes.
(2) 2.0 g of 28% ammonia water, 15.0 g of tetraethoxysilane, and 5.0 g of a colloidal silica aqueous dispersion liquid A (silica solid content: 40% by mass, particle diameter of 40 nm) were added thereto, and the mixture was stirred at 30° C. for 3.0 hours, thereby obtaining a raw material solution.

### 2. Granulation Step:

120.0 g of RO water was put into a 1000 ml beaker, and the raw material solution obtained in the step 1 was added dropwise thereto for 5 minutes while the mixture was stirred at 25° C. Thereafter, the mixed solution was heated to 60° C. and stirred for 1.5 hours while the temperature of the solution was maintained at 60° C., thereby obtaining a dispersion liquid of the composite particles.

### 3. Hydrophobization Step:

6.0 g of hexamethyldisilazane was added, as a hydrophobizing agent, to the dispersion liquid of the composite particles obtained in 2. Granulation step described above, and the solution was stirred at 60° C. for 3.0 hours. The solution was allowed to stand for 5 minutes, and the powder precipitated in the lower portion of the solution was recovered by suction filtration and dried under reduced pressure at 120° C. for 24 hours, thereby obtaining composite particles 1. The number average particle diameter of the primary particles of the composite particles 1 was 0.12 μm. The physical properties of the composite particles 1 are listed in Table 1.

### Production Example of Composite Particles 2

Composite particles 2 were obtained in the same manner as in the production example of the composite particles 1 except that the amount of dimethyldimethoxysilane was changed to 14.5 g in the item (1) of 1. Hydrolysis and polycondensation step described above and the amount of the tetraethoxysilane was changed to 12.7 g in the item (2) thereof.

### Production Example of Composite Particles 3

Composite particles 3 were obtained in the same manner as in the production example of the composite particles 1 except that the amount of dimethyldimethoxysilane was changed to 7.2 g in the item (1) of 1. Hydrolysis and polycondensation step described above and the amount of the tetraethoxysilane was changed to 20.0 g in the item (2) thereof.

### Production Example of Composite Particles 4

Composite particles 4 were obtained in the same manner as in the production example of the composite particles 1 except that the amount of dimethyldimethoxysilane was changed to 7.2 g in the item (1) of 1. Hydrolysis and polycondensation step described above and 20.0 g of trimethoxymethylsilane was added without adding tetraethoxysilane in the item (2) thereof.

### Production Example of Composite Particles 5

Composite particles 5 were obtained in the same manner as in the production example of the composite particles 1 except that the amount of the colloidal silica aqueous dispersion liquid A (silica solid content: 40% by mass, particle diameter: 40 nm) to be added was changed to 10.0 g in the item (2) of 1. Hydrolysis and polycondensation step described above.

### Production Example of Composite Particles 6

Composite particles 6 were obtained in the same manner as in the production example of the composite particles 1 except that the amount of the colloidal silica aqueous dispersion liquid A (silica solid content: 40% by mass, particle diameter: 40 nm) to be added was changed to 15.0 g in the item (2) of 1. Hydrolysis and polycondensation step described above.

### Production Example of Composite Particles 7

Composite particles 7 were obtained in the same manner as in the production example of the composite particles 1 except that the amount of the colloidal silica aqueous dispersion liquid A (silica solid content: 40% by mass, particle diameter: 40 nm) to be added was changed to 2.5 g in the item (2) of 1. Hydrolysis and polycondensation step described above.

### Production Example of Composite Particles 8

Composite particles 8 were obtained in the same manner as in the production example of the composite particles 1 except that an alumina aqueous dispersion liquid (alumina solid content: 30% by mass, particle diameter of 40 nm) was used in place of the colloidal silica aqueous dispersion liquid A (silica solid content: 40% by mass, particle diameter: 40 nm) in the item (2) of 1. Hydrolysis and polycondensation step described above.

### Production Example of Composite Particles 9

Composite particles 9 were obtained in the same manner as in the production example of the composite particles 1 except that 7.0 g of a titanium oxide aqueous dispersion liquid (titanium oxide solid content: 40% by mass, particle diameter of 30 nm) was used in place of 5.0 g of the colloidal silica aqueous dispersion liquid A in the item (2) of 1. Hydrolysis and polycondensation step described above.

### Production Example of Composite Particles 10

Composite particles 10 were obtained in the same manner as in the production example of the composite particles 1 except that the amount of 28% ammonia water was changed to 1.0 g, the stirring temperature was changed to 40° C., and the stirring time was changed to 3.5 hours in the item (2) of 1. Hydrolysis and polycondensation step described above.

### Production Example of Composite Particles 11

Composite particles 11 were obtained in the same manner as in the production example of the composite particles 1 except that the amount of 28% ammonia water was changed to 3.0 g and the stirring temperature was changed to 25° C. in the item (2) of 1. Hydrolysis and polycondensation step described above.

### Production Example of Composite Particles 12

Composite particles 12 were obtained in the same manner as in the production example of the composite particles 1 except that the amount of 28% ammonia water was changed to 5.0 g, the stirring temperature was changed to 25° C., and the stirring time was changed to 2.0 hours in the item (2) of 1. Hydrolysis and polycondensation step described above.

### Production Example of Composite Particles 13

Composite particles 13 were obtained in the same manner as in the production example of the composite particles 1 except that the amount of trimethoxymethylsilane was changed to 27.2 g without adding dimethyldimethoxysilane in the item (1) of 1. Hydrolysis and polycondensation step described above and tetraethoxysilane was not added in the item (2) thereof.

### Production Example of Composite Particles 14

### 1. Hydrolysis and Polycondensation Step:

(1) A 500 ml beaker was charged with 21.6 g of RO water, 135.0 g of methanol, 0.004 g of acetic acid as a catalyst, and 12.2 g of dimethyldimethoxysilane, and the mixture was stirred at 45° C. for 5 minutes.
(2) 2.0 g of 28% ammonia water and 15.0 g of tetraethoxysilane were added thereto, and the mixture was stirred at 30° C. for 2.0 hours.
(3) 5.0 g of a colloidal silica aqueous dispersion liquid A (silica solid content: 40% by mass, particle diameter of 40 nm) was added thereto, and the mixture was stirred for 10 minutes, thereby obtaining a raw material solution.

### 2. Granulation Step:

120.0 g of RO water was put into a 1000 ml beaker, and the raw material solution obtained in the step 1 was added dropwise thereto for 5 minutes while the mixture was stirred at 25° C. Thereafter, the mixed solution was heated to 60° C. and stirred for 1.5 hours while the temperature of the solution was maintained at 60° C., thereby obtaining a dispersion liquid of the composite particles.

### 3. Hydrophobization Step:

6.0 g of hexamethyldisilazane was added, as a hydrophobizing agent, to the dispersion liquid of the external additive fine particles obtained in 2. Granulation step described above, and the solution was stirred at 60° C. for 3.0 hours. The solution was allowed to stand for 5 minutes, and the powder precipitated in the lower portion of the solution was recovered by suction filtration and dried under reduced pressure at 120° C. for 24 hours, thereby obtaining composite particles 14.

### Production Example of Composite Particles 15

Composite particles 15 were obtained in the same manner as in the production example of the composite particles 1 except that a colloidal silica aqueous dispersion liquid B (silica solid content: 40% by mass, particle diameter: 80 nm) was used in place of the colloidal silica aqueous dispersion liquid A (silica solid content: 40% by mass, particle diameter: 40 nm) in the item (2) of 1. Hydrolysis and polycondensation step described above.

### Production Example of Composite Particles 16

Composite particles 16 were obtained in the same manner as in the production example of the composite particles 1 except that a polyester resin fine particle dispersion liquid (solid content: 25% by mass, particle diameter: 50 nm) was used in place of the colloidal silica aqueous dispersion liquid A (silica solid content: 40% by mass, particle diameter: 40 nm) in the item (2) of 1. Hydrolysis and polycondensation step described above.

### Production Example of Composite Particles 17

Composite particles 17 were obtained in the same manner as in the production example of the composite particles 1 except that the amount of dimethyldimethoxysilane was changed to 3.2 g in the item (1) of 1. Hydrolysis and polycondensation step described above and the amount of the tetraethoxysilane was changed to 24.0 g in the item (2) thereof.

### Production Example of Composite Particles 18

A 250 mL four-necked round bottom flask equipped with an overhead stirring motor, a condenser, and a thermocouple was charged with 18.7 g of a colloidal silica dispersion liquid (silica solid content: 40% by mass, particle diameter: 40 nm), 125 mL of DI water, and 16.5 g (0.066 moles) of methacryloxypropyl-trimethoxysilane. The temperature was increased to 65° C., and the mixture was stirred at 120 rpm. The mixture was foamed for 30 minutes by allowing nitrogen gas to pass through the mixture. After 3 hours, 0.16 g of a 2,2′-azobisisobutyronitrile radical initiator dissolved in 10 mL of ethanol was added to the mixture, and the temperature thereof was increased to 75° C.

The radical polymerization was allowed to proceed for 5 hours, and 3 mL of 1,1,1,3,3,3-hexamethyldisilazane was added to the mixture. The reaction was allowed to further proceed for additional 3 hours. The final mixture was filtered through a 170 mesh sieve to remove the coagulation material, and the dispersion liquid was dried in a Pyrex (registered trademark) dish at 120° C. overnight, thereby obtaining composite particles 18.

The physical properties of the composite particles 1 to 18 are listed in Table 1.

TABLE 1

| | Fine particles A | | | | Fine particles B | | | |
|---|---|---|---|---|---|---|---|---|
| Composite | | Proportion of | | | | Particle | Young's | Embedding |
| particles | | configuration | | | | diameter | modulus | Ratio |
| No. | Compound | Pa | Pb | Pc | Compound | μm | GPa | % |
| Composite | Organic silicon | 0.40 | 0.00 | 0.60 | Silica | 0.04 | 70 | 60 |
| particles 1 | compound | | | | | | | |
| Composite | Organic silicon | 0.35 | 0.00 | 0.65 | Silica | 0.04 | 70 | 60 |
| particles 2 | compound | | | | | | | |
| Composite | Organic silicon | 0.65 | 0.93 | 0.35 | Silica | 0.04 | 70 | 60 |
| particles 3 | compound | | | | | | | |
| Composite | Organic silicon | 0.00 | 0.80 | 0.20 | Silica | 0.04 | 70 | 60 |
| particles 4 | compound | | | | | | | |
| Composite | Organic silicon | 0.40 | 0.00 | 0.60 | Silica | 0.04 | 70 | 60 |
| particles 5 | compound | | | | | | | |
| Composite | Organic silicon | 0.40 | 0.00 | 0.60 | Silica | 0.04 | 70 | 60 |
| particles 6 | compound | | | | | | | |
| Composite | Organic silicon | 0.40 | 0.00 | 0.60 | Silica | 0.04 | 70 | 60 |
| particles 7 | compound | | | | | | | |
| Composite | Organic silicon | 0 40 | 0.00 | 0.60 | Alumina | 0.04 | 70 | 60 |
| particles 8 | compound | | | | | | | |
| Composite | Organic silicon | 0.40 | 0.00 | 0.60 | Titanium | 0.03 | 45 | 60 |
| particles 9 | compound | | | | oxide | | | |
| Composite | Organic silicon | 0.40 | 0.00 | 0.60 | Silica | 0.04 | 70 | 60 |
| particles 10 | compound | | | | | | | |
| Composite | Organic silicon | 0.40 | 0.00 | 0.60 | Silica | 0.04 | 70 | 60 |
| particles 11 | compound | | | | | | | |
| Composite | Organic silicon | 0.40 | 0.00 | 0.60 | Silica | 0.04 | 70 | 60 |
| particles 12 | compound | | | | | | | |
| Composite | Organic silicon | 0.00 | 1.00 | 0.00 | Silica | 0.04 | 70 | 60 |
| particles 13 | compound | | | | | | | |
| Composite | Organic silicon | 0.40 | 0.00 | 0.60 | Silica | 0.04 | 70 | 20 |
| particles 14 | compound | | | | | | | |
| Composite | Organic silicon | 0.40 | 0.00 | 0.60 | Silica | 0.08 | 70 | 60 |
| particles 15 | compound | | | | | | | |
| Composite | Organic silicon | 0.40 | 0.00 | 0.60 | Polyester | 0.04 | 20 | 60 |
| particles 16 | compound | | | | | | | |
| Composite | Organic silicon | 0.80 | 0.00 | 0.20 | Silica | 0.04 | 70 | 60 |
| particles 17 | compound | | | | | | | |
| Composite | Acrylic resin | 0.00 | 0.00 | 0.00 | Silica | 0.04 | 40 | 60 |
| particles 18 | | | | | | | | |

| | | | True | Specific | |
|---|---|---|---|---|---|
| Composite | Particle | Young's | specific | surface | |
| particles | diameter | modulus | gravity | area | Surface treatment |
| No. | μm | GPa | g/cm³ | m²/g | hydrophobizing agent |
| Composite | 0.12 | 15 | 1.35 | 120 | Hexamethyldisilazane |
| particles 1 | | | | | |
| Composite | 0.12 | 10 | 1.35 | 120 | Hexamethyldisilazane |
| particles 2 | | | | | |
| Composite | 0.12 | 30 | 1.35 | 120 | Hexamethyldisilazane |
| particles 3 | | | | | |
| Composite | 0.12 | 8 | 1.35 | 120 | Hexamethyldisilazane |
| particles 4 | | | | | |
| Composite | 0.12 | 20 | 1.55 | 230 | Hexamethyldisilazane |
| particles 5 | | | | | |
| Composite | 0.12 | 25 | 1.65 | 260 | Hexamethyldisilazane |
| particles 6 | | | | | |
| Composite | 0.12 | 15 | 1.20 | 65 | Hexamethyldisilazane |
| particles 7 | | | | | |
| Composite | 0.12 | 15 | 1.35 | 120 | Hexamethyldisilazane |
| particles 8 | | | | | |
| Composite | 0.12 | 15 | 1.35 | 120 | Hexamethyldisilazane |
| particles 9 | | | | | |
| Composite | 0.05 | 15 | 1.35 | 160 | Hexamethyldisilazane |
| particles 10 | | | | | |
| Composite | 0.30 | 15 | 1.35 | 90 | Hexamethyldisilazane |
| particles 11 | | | | | |
| Composite | 0.35 | 15 | 1.35 | 85 | Hexamethyldisilazane |
| particles 12 | | | | | |
| Composite | 0.12 | 12 | 1.35 | 120 | Hexamethyldisilazane |
| particles 13 | | | | | |
| Composite | 0.12 | 15 | 1.35 | 150 | Hexamethyldisilazane |
| particles 14 | | | | | |
| Composite | 0.12 | 15 | 1.35 | 100 | Hexamethyldisilazane |
| particles 15 | | | | | |
| Composite | 0.12 | 15 | 1.20 | 120 | Hexamethyldisilazane |
| particles 16 | | | | | |
| Composite | 0.12 | 32 | 1.45 | 120 | Hexamethyldisilazane |
| particles 17 | | | | | |
| Composite | 0.12 | 40 | 1.90 | 170 | Hexamethyldisilazane |
| particles 18 | | | | | |

### Production Example of Polyester Resin A1

Polyoxypropylene (2.2)-2,2-bis(4-hydroxyphenyl)propane: 76.9 parts (0.167 moles)
Terephthalic acid (TPA): 25.0 parts (0.145 moles)
Adipic acid: 8.0 parts (0.054 moles)
Titanium tetrabutoxide: 0.5 parts

The above-described materials were placed in a 4 L four-necked glass flask, and a thermometer, a stirring rod, a condenser, and a nitrogen introduction tube were attached to the flask and placed in a mantle heater. Next, the inside of the flask was substituted with nitrogen gas and gradually heated while the mixture was stirred, and the mixture was allowed to react for 4 hours while being stirred at a temperature of 200° C. (first reaction step). Thereafter, 1.2 parts (0.006 moles) of trimellitic anhydride (TMA) was added thereto, and the mixture was allowed to react at 180° C. for 1 hour (second reaction step), thereby obtaining a polyester resin A1 serving as a binder resin component. The acid value of the polyester resin A1 was 5 mgKOH/g.

### Production Example of Polyester Resin A2

Polyoxypropylene (2.2)-2,2-bis(4-hydroxyphenyl)propane: 71.3 parts (0.155 moles)
Terephthalic acid: 24.1 parts (0.145 moles)
Titanium tetrabutoxide: 0.6 parts

The above-described materials were placed in a 4 L four-necked glass flask, and a thermometer, a stirring rod, a condenser, and a nitrogen introduction tube were attached to the flask and placed in a mantle heater. Next, the inside of the flask was substituted with nitrogen gas and gradually heated while the mixture was stirred, and the mixture was allowed to react for 2 hours while being stirred at a temperature of 200° C. Thereafter, 5.8 parts (0.030% by mole) of trimellitic anhydride was added thereto, and the mixture was allowed to react at 180° C. for 10 hours, thereby obtaining a polyester resin A2 serving as a binder resin component. The acid value of the polyester resin A2 was 10 mgKOH/g.

### Production Example of Crystalline Polyester 1

A reaction vessel provided with a nitrogen introduction tube, a dehydration tube, a stirrer, and a thermocouple was charged with 100.0 parts by mole of 1,10-decanedicarboxylic acid as a carboxylic acid monomer and 100.0 parts by mole of 1,6-hexanediol as an alcohol monomer. The mixture was heated to 140° C. while being stirred, heated to 140° C. in a nitrogen atmosphere, and allowed to react for 8 hours while water was distilled off under normal pressure.

Next, 0.57 parts of tin dioctylate was added to 100 parts of a combination of a carboxylic acid monomer and an alcohol monomer, and the mixture was allowed to react while being heated to 200° C. at 10° C./hour.

Further, after the temperature reached 200° C., the reaction was continued for 2 hours, the pressure inside the reaction vessel was reduced to 5 kPa or less, and the reaction was carried out while the molecular weight was monitored at 200° C., thereby obtaining crystalline polyester 1. The melting point of the crystalline polyester 1 was 67° C., and the weight-average molecular weight thereof was 2.4×10⁴.

### Production Example of Crystalline Polyester 2

Crystalline polyester 2 was obtained in the same manner as in the production example of the crystalline polyester 1 except that 1,12-dodecanedicarboxylic acid was used in place of the carboxylic acid monomer, 1,10-decanediol was used in place of the alcohol monomer, and the reaction time was changed. The melting point of the crystalline polyester 2 was 78° C., and the weight-average molecular weight thereof was 2.3×10⁴.

### Production Example of Crystalline Polyester 3

Crystalline polyester 3 was obtained in the same manner as in the production example of the crystalline polyester 1 except that 1,18-octadecanedicarboxylic acid was used in place of the carboxylic acid monomer and the reaction time was changed. The number of carbon atoms in the straight-chain hydrocarbon chain of the 1,18-octadecanedicarboxylic acid used here was 18, the melting point of the crystalline polyester 3 was 75° C., and the weight-average molecular weight thereof was 2.0×10⁴.

### Production Example of Toner Particles 1

Polyester resin A1:70.0 parts
Polyester resin A2:30.0 parts
Crystalline polyester 1:6.0 parts
Fischer-Tropsch wax (peak temperature of maximum endothermic peak: 78° C.): 5.0 parts
C.I. Pigment Blue 15:3:5.0 parts

The raw materials shown in the above-described formulation were mixed at a rotation speed of 20 s⁻¹ for a rotation time of 5 minutes using a Henschel mixer (FM-75 model, manufactured by NIPPON COKE & ENGINEERING CO., LTD.) and kneaded by a twin screw kneader (PCM-30 model, manufactured by IKEGAI CO., LTD.) set at a temperature of 125° C. and a rotation speed of 300 rpm. The obtained kneaded material was cooled, coarsely pulverized to a diameter of 1 mm or less using a hammer mill to obtain a coarsely pulverized material. The obtained coarsely pulverized material was finely pulverized using a mechanical pulverizer (T-250, manufactured by FREUND-TURBO CORPORATION). Further, classification was performed using a rotary classifier (200TSP, manufactured by Hosokawa Micron Corporation), thereby obtaining toner particles 1. The rotary classifier was operated under a condition of a classification rotor rotation speed of 50.0 s⁻¹. The obtained toner particles 1 had a weight-average molecular weight (D4) of 5.9 μm.

### Production Examples of Toner Particles 2 to 8

Toner particles 2 to 8 were obtained in the same manner as described above except that the kind and the addition amount of the crystalline polyester were changed as listed in Table 2 in the production example of the toner particles 1.

### Production Example of Toner 1

Toner particles 1:100 parts
Composite particles 1:6.0 parts

The above-described materials were mixed at a rotation speed of 30 s⁻¹ for a rotation time of 10 min using a Henschel mixer FM-10c model (manufactured by Mitsui Mike Kakoki Co., Ltd.), thereby obtaining a toner 1.

### Production Examples of Toners 2 to 25

Toners 2 to 25 were obtained by performing production in the same manner as described above except that the kind of the toner particles, and the kind and the addition amount of the composite particles were changed as listed in Table 2 in the production example of the toner 1.

TABLE 2

| | | Crystalline polyester | | Composite particles | |
|---|---|---|---|---|---|
| Toner | Toner particles | | Addition amount | | Addition amount |
| No. | No. | No. | (parts) | No. | (parts) |
| Toner 1 | Toner particles 1 | Crystalline polyester 1 | 6.0 | Composite particles 1 | 6.0 |
| Toner 2 | Toner particles 2 | Crystalline polyester 1 | 3.0 | Composite particles 1 | 6.0 |
| Toner 3 | Toner particles 3 | Crystalline polyester 1 | 15.0 | Composite particles 1 | 6.0 |
| Toner 4 | Toner particles 4 | Crystalline polyester 1 | 2.0 | Composite particles 1 | 6.0 |
| Toner 5 | Toner particles 5 | Crystalline polyester 1 | 18.0 | Composite particles 1 | 6.0 |
| Toner 6 | Toner particles 1 | Crystalline polyester 1 | 6.0 | Composite particles 2 | 6.0 |
| Toner 7 | Toner particles 1 | Crystalline polyester 1 | 6.0 | Composite particles 3 | 6.0 |
| Toner 8 | Toner particles 1 | Crystalline polyester 1 | 6.0 | Composite particles 4 | 6.0 |
| Toner 9 | Toner particles 1 | Crystalline polyester 1 | 6.0 | Composite particles 5 | 6.0 |
| Toner 10 | Toner particles 1 | Crystalline polyester 1 | 6.0 | Composite particles 6 | 6.0 |
| Toner 11 | Toner particles 1 | Crystalline polyester 1 | 6.0 | Composite particles 7 | 6.0 |
| Toner 12 | Toner particles 6 | Crystalline polyester 2 | 6.0 | Composite particles 1 | 6.0 |
| Toner 13 | Toner particles 7 | Crystalline polyester 3 | 6.0 | Composite particles 1 | 6.0 |
| Toner 14 | Toner particles 1 | Crystalline polyester 1 | 6.0 | Composite particles 8 | 6.0 |
| Toner 15 | Toner particles 1 | Crystalline polyester 1 | 6.0 | Composite particles 9 | 6.0 |
| Toner 16 | Toner particles 1 | Crystalline polyester 1 | 6.0 | Composite particles 10 | 6.0 |
| Toner 17 | Toner particles 1 | Crystalline polyester 1 | 6.0 | Composite particles 11 | 6.0 |
| Toner 18 | Toner particles 1 | Crystalline polyester 1 | 6.0 | Composite particles 12 | 6.0 |
| Toner 19 | Toner particles 1 | Crystalline polyester 1 | 6.0 | Composite particles 13 | 6.0 |
| Toner 20 | Toner particles 1 | Crystalline polyester 1 | 6.0 | Composite particles 14 | 6.0 |
| Toner 21 | Toner particles 1 | Crystalline polyester 1 | 6.0 | Composite particles 15 | 6.0 |
| Toner 22 | Toner particles 1 | Crystalline polyester 1 | 6.0 | Composite particles 16 | 6.0 |
| Toner 23 | Toner particles 1 | Crystalline polyester 1 | 6.0 | Composite particles 17 | 6.0 |
| Toner 24 | Toner particles 1 | Crystalline polyester 1 | 6.0 | Composite particles 18 | 6.0 |
| Toner 25 | Toner particles 8 | — | — | Composite particles 1 | 6.0 |

### Production Example of Carrier 1

Magnetite 1 with number average particle diameter of 0.30 μm (magnetization strength of 65 Am2/kg in magnetic field of 1000/4π (kA/m))
Magnetite 2 with number average particle diameter of 0.50 μm (magnetization strength of 65 Am2/kg in magnetic field of 1000/4π (kA/m))

4.0 parts of a silane compound (3-(2-aminoethylaminopropyl) trimethoxysilane) was added to 100 parts of each of the above-described materials, the mixture was mixed and stirred in a container at 100° C. or higher at a high speed to treat each of fine particles.
Phenol: 10% by mass
Formaldehyde solution: 6% by mass (40% by mass of formaldehyde, 10% by mass of methanol, 50% by mass of water)
Magnetite 1 treated with silane compound described above: 58% by mass
Magnetite 2 treated with silane compound described above: 26% by mass

100 parts of the above-described materials, 5 parts of a 28 mass % ammonia aqueous solution, and 20 parts of water were placed in a flask, heated to 85° C. and maintained at the temperature for 30 minutes while being stirred and mixed, and subjected to a polymerization reaction for 3 hours to cure a phenol resin generated. Thereafter, the cured phenol resin was cooled to 30° C., water was further added thereto, the supernatant was removed, and the precipitate was washed with water and air-dried. Next, the resultant was dried at a temperature of 60° C. under reduced pressure (5 mmHg or less), thereby obtaining a spherical magnetic material dispersed carrier 1. The 50% particle diameter (D50) thereof on a volume basis was 34.2 μm.

### Production Example of Two-Component Developer 1

8.0 parts of the toner 1 was added with respect to 92.0 parts of the carrier 1, and the mixture was mixed with a V type mixer (V-20, manufactured by SEISHIN ENTERPRISE Co., Ltd.), thereby obtaining a two-component developer 1.

### Production Examples of Two-Component Developers 2 to 25

Two-component developers 2 to 25 were obtained by performing production in the same manner as described above except that the toner was changed as listed in Table 3 in the production example of the two-component developer 1.

TABLE 3

| Two-component developer No. | Toner No. | Carrier No. |
|---|---|---|
| Two-component developer 1 | Toner 1 | Carrier 1 |
| Two-component developer 2 | Toner 2 | Carrier 1 |
| Two-component developer 3 | Toner 3 | Carrier 1 |
| Two-component developer 4 | Toner 4 | Carrier 1 |
| Two-component developer 5 | Toner 5 | Carrier 1 |
| Two-component developer 6 | Toner 6 | Carrier 1 |
| Two-component developer 7 | Toner 7 | Carrier 1 |
| Two-component developer 8 | Toner 8 | Carrier 1 |
| Two-component developer 9 | Toner 9 | Carrier 1 |
| Two-component developer 10 | Toner 10 | Carrier 1 |
| Two-component developer 11 | Toner 11 | Carrier 1 |
| Two-component developer 12 | Toner 12 | Carrier 1 |
| Two-component developer 13 | Toner 13 | Carrier 1 |
| Two-component developer 14 | Toner 14 | Carrier 1 |
| Two-component developer 15 | Toner 15 | Carrier 1 |
| Two-component developer 16 | Toner 16 | Carrier 1 |
| Two-component developer 17 | Toner 17 | Carrier 1 |
| Two-component developer 18 | Toner 18 | Carrier 1 |
| Two-component developer 19 | Toner 19 | Carrier 1 |
| Two-component developer 20 | Toner 20 | Carrier 1 |
| Two-component developer 21 | Toner 21 | Carrier 1 |
| Two-component developer 22 | Toner 22 | Carrier 1 |
| Two-component developer 23 | Toner 23 | Carrier 1 |
| Two-component developer 24 | Toner 24 | Carrier 1 |
| Two-component developer 25 | Toner 25 | Carrier 1 |

### Example 1

### Method of Evaluating Toner

The following evaluation was performed using the two-component developer 1.

A modified machine imageRUNNER ADVANCE C5560 (manufactured by CANON INC.), which is a printer for digital commercial printing, was used as an image forming apparatus, and the two-component developer was placed in a cyan developing device. The apparatus was modified such that the fixing temperature, the process speed, the direct current voltage VDC of the developer carrier, the charging voltage VD of the electrostatic latent image carrier, and the laser power could be freely set.

Image output was evaluated by outputting an FFh image (solid image) having a desired image ratio and adjusting VDC, VD, and the laser power such that the amount of the toner mounted on the FFh image on paper reached a desired value, and the following evaluation was performed. FFh is a value that expresses 256 gradations in hexadecimal, 00h is the first gradation (white background portion) of the 256 gradations, and FFh is the 256th gradation (solid portion) of the 256 gradations.

### (1) Evaluation of Abrasion Resistance

Paper: OK Topcoat Mat N157 (157.0 g/m²) (heavyweight coated paper sold by Oji Paper Co., Ltd., calcium carbonate was used as coating material)
Amount of toner mounted on paper: 0.05 mg/cm² (2Fh image) (adjusted by direct current voltage VDC of developer carrier, charging voltage VD of electrostatic latent image carrier, and laser power)
Evaluation image: 3 cm×15 cm image disposed at center of A4 paper described above
Fixing test environment: normal temperature and normal humidity environment (temperature of 23° C./relative humidity of 50% (hereinafter, referred to as N/N))
Fixing temperature: 180° C.
Process speed: 348 mm/sec

The evaluation image was output and the abrasion resistance was evaluated under the above-described evaluation conditions. The value of a difference in reflectivity was used as an evaluation index for the abrasion resistance.

First, an image area of the evaluation image was rubbed (reciprocation performed 10 times) with new evaluation paper by applying a load of 1.0 kgf using a Gakushin type rubbing fastness tester (AB-301: manufactured by TESTOR SANGYO CO., LTD.). Thereafter, the reflectivity of a portion rubbed with the new evaluation paper and the reflectivity of a portion that had not been rubbed with the new evaluation paper were measured using a reflectometer (REFLECTOMETER MODEL TC-6DS: manufactured by Tokyo Denshoku Co., Ltd.).

Further, a difference in reflectivity before and after rubbing was calculated by the following equation. The obtained difference in reflectivity was ranked according to the following criteria. A rank of D or higher was determined to be satisfactory.

Difference in reflectivity=reflectivity of portion that had not been rubbed−reflectivity of portion rubbed

### Evaluation Criteria

A: less than 1.0%
B: 1.0% or greater and less than 5.0%
C: 5.0% or greater and less than 10.0%
D: 10.0% or greater and less than 15.0%
E: 15.0% or greater

### (2) Evaluation of Scratch Resistance

Paper: Oce Top Coated Pro Silk 270 (270.0 g/m²) (sold by Oce)
Amount of toner mounted on paper: 0.80 mg/cm²
Evaluation image: 3 cm×15 cm image disposed at center of A4 paper described above
Test environment: normal temperature and normal humidity environment (temperature of 23° C./relative humidity of 50% (hereinafter, referred to as N/N))
Fixing temperature: 160° C.
Process speed: 400 mm/s

A 200 g weight was placed on recording paper onto which the above-described evaluation image had been output, the surface of the image was scratched by a length of 30 mm with a needle having a diameter of 0.75 mm at a speed of 60 mm/min using a surface property tester HEIDON TYPE 14FW (manufactured by SHINTO Scientific Co., Ltd.), and the scratch resistance was evaluated based on the scratch on the image.

Further, the ratio of the area where the toner had been peeled off was determined by performing image processing to binarize the area where the toner had been peeled off with respect to the scratched area. The evaluation results were ranked according to the following criteria. A rank of D or higher was determined to be satisfactory.

### Evaluation Criteria

A: The ratio of the area where the toner had been peeled off due to the scratch on the image was less than 1.0%.
B: The ratio of the area where the toner had been peeled off due to the scratch on the image was 1.0% or greater and less than 4.0%.
C: The ratio of the area where the toner had been peeled off due to the scratch on the image was 4.0% or greater and less than 7.0%.
D: The ratio of the area where the toner had been peeled off due to the scratch on the image was 7.0% or greater and less than 10.0%.
E: The ratio of the area where the toner had been peeled off due to the scratch on the image was 10.0% or greater.

### Examples 2 to 19

Two-component developers 2 to 19 were evaluated in the same manner as in Example 1. The evaluation results of Examples 2 to 19 are listed in Table 4.

### Comparative Examples 1 to 6

Two-component developers 20 to 25 were evaluated in the same manner as in Example 1. The evaluation results of Comparative Examples 1 to 5 are listed in Table 4.

TABLE 4

| | | Abrasion resistance | | Scratch | |
|---|---|---|---|---|---|
| | | Difference in | | resistance | |
| | | reflectivity (%) | | Area ratio (%) | |
| | | Numerical | | Numerical | |
| | Two-component developer No. | value | Rank | value | Rank |
| Example 1 | Two-component developer 1 | 0.4 | A | 0.6 | A |
| Example 2 | Two-component developer 2 | 0.6 | A | 1.8 | B |
| Example 3 | Two-component developer 3 | 0.9 | A | 2.7 | B |
| Example 4 | Two-component developer 4 | 1.6 | B | 2.2 | B |
| Example 5 | Two-component developer 5 | 2.1 | B | 3.1 | B |
| Example 6 | Two-component developer 6 | 0.6 | A | 3.4 | B |
| Example 7 | Two-component developer 7 | 0.6 | A | 3.3 | B |
| Example 8 | Two-component developer 8 | 2.4 | B | 2.9 | B |
| Example 9 | Two-component developer 9 | 0.7 | A | 3.2 | B |
| Example 10 | Two-component developer 10 | 3.0 | B | 3.8 | B |
| Example 11 | Two-component developer 11 | 3.5 | B | 4.5 | C |
| Example 12 | Two-component developer 12 | 3.3 | B | 5.6 | C |
| Example 13 | Two-component developer 13 | 2.8 | B | 6.2 | C |
| Example 14 | Two-component developer 14 | 4.6 | B | 6.1 | C |
| Example 15 | Two-component developer 15 | 5.2 | C | 5.2 | C |
| Example 16 | Two-component developer 16 | 6.9 | C | 6.7 | C |
| Example 17 | Two-component developer 17 | 8.4 | C | 6.8 | C |
| Example 18 | Two-component developer 18 | 11.0 | D | 8.9 | D |
| Example 19 | Two-component developer 19 | 3.4 | B | 6.3 | C |
| Comparative Example 1 | Two-component developer 20 | 13.7 | D | 10.7 | E |
| Comparative Example 2 | Two-component developer 21 | 15.5 | E | 12.5 | E |
| Comparative Example 3 | Two-component developer 22 | 17.2 | E | 13.1 | E |
| Comparative Example 4 | Two-component developer 23 | 17.5 | E | 14.3 | E |
| Comparative Example 5 | Two-component developer 24 | 18.0 | E | 14.2 | E |
| Comparative Example 6 | Two-component developer 25 | 19.6 | E | 14.8 | E |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-174000, filed Oct. 6, 2023, which is hereby incorporated by reference herein in its entirety.

What is claimed is:

1. A toner comprising:
a toner particle containing a binder resin and crystalline polyester; and
a composite particle present on a surface of the toner particle,
wherein the composite particle includes a fine particle A containing, as a binder component, an organic silicon compound that has a siloxane bond, and a fine particle B which is an inorganic fine particle,
wherein the fine particle B is present in a state where a part of the fine particle B is embedded in a surface of the fine particle A,
wherein Pa is a proportion of a silicon atom represented by Si^{a} in a structure represented by a unit (a), Pb is a proportion of a silicon atom represented by Si^{b} in a structure represented by a unit (b), and Pc is a proportion of a silicon atom represented by Si^{c} in a structure represented by a unit (c) based on all silicon atoms contained in the organic silicon compound of the fine particle A, and
wherein Pa, Pb, and Pc satisfy Expressions (1) to (3),
$$\begin{matrix}( 1 ) P a + P b + P c \geq 0.80 \\ ( 2 ) Pb + Pc \geq 0.30 \\ ( 3 ) P a / ( P a + Pb + Pc ) \leq 0.7\end{matrix}$$ 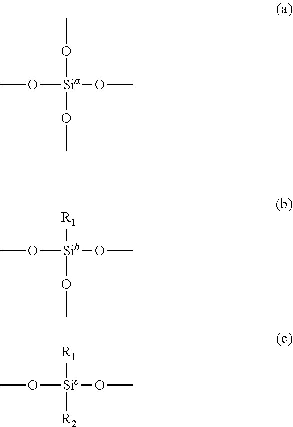
wherein R₁ and R₂ represent an alkyl group having 1 or more and 6 or less carbon atoms,
wherein a primary particle of the fine particle B has a number average particle diameter of 0.01 μm or greater and 0.06 μm or less, and
wherein an average value of embedding ratios of the fine particle B represented by the following equation to the fine particle A in the composite particle is 30% or greater and 90% or less,
embedding ratio (%) of fine particle B to fine particle A=(depth of fine particle B embedded in fine particle A/diameter of fine particle B)×100.

2. The toner according to claim 1,
wherein the primary particle of the composite particle has a number average particle diameter of 0.02 μm or greater and 0.30 μm or less.

3. The toner according to claim 1,
wherein the fine particle B is silica or alumina.

4. The toner according to claim 1,
wherein the fine particle B has a Young's modulus of 50 GPa or greater and 200 GPa or less.

5. The toner according to claim 1,
wherein the crystalline polyester contains a monomer having a straight-chain hydrocarbon chain with 8 or more and 12 or less carbon atoms.

6. The toner according to claim 1,
wherein Pa, Pb, and Pc in the fine particle A satisfy Expressions (I), (II), and (III),
$$0.3 \leq P a / ( P a + P b + P c ) \leq 0.8 \qquad ( I )$$
$$0 \leq Pb / ( P a + P b + P c ) \leq 0.50 \qquad ( II )$$
$$0.2 \leq Pc / ( P a + P b + P c ) \leq 0.7 . \qquad ( III )$$

7. The toner according to claim 1,
wherein the composite particle has a Brunauer-Emmett-Teller (BET) specific surface are of 70 m²/g or greater and 250 m²/g or less.

8. The toner according to claim 1,
wherein the composite particle has a true specific gravity of 1.00 g/cm³ or greater and 1.60 g/cm³ or less.

9. The toner according to claim 1,
wherein the composite particle has a Young's modulus of 10 GPa or greater and 30 GPa or less.

10. The toner according to claim 1,
wherein a content of the crystalline polyester is 3.0 parts by mass or greater and 15.0 parts by mass or less with respect to 100 parts by mass of the binder resin.
